(19) United States
(12) Patent Application Publication
(10) Pub. No.: US 2026/0243230 A1
(43) Pub. Date: Aug. 20, 2026

(54) INTEGRATIVE SYSTEM FOR CENTRALISED OFFSHORE HYDROGEN PRODUCTION IN CONJUNCTION WITH A FLOATING GENERATION AND STORAGE UNIT

(71) Applicant: Siemens Energy Global GmbH & Co. KG, München (DE)

(72) Inventors: Maximilian Keim, Hannover (DE); Carolin Weber, Hamburg (DE); Thorsten Steinhoff, Hamburg (DE)

(21) Appl. No.: 19/161,757

(22) PCT Filed: May 22, 2024
(86) PCT No.: PCT/EP2024/064028

§ 371 Date: Sep. 3, 2025

(30) Foreign Application Priority Data
Jun. 7, 2023 (DE) 10 2023 205 344.6

(51) Int. Cl. F03D 13/25; B63B 35/44; F03D 9/19; F03D 9/25

(52) U.S. Cl. CPC F03D 13/25; F03D 9/19; B63B 2035/446; B63B 2035/448; F03D 9/25; F05B 2220/61; F05B 2240/95

(57) ABSTRACT

The invention relates to a system for generating energy in open water, in which an offshore wind turbine is releasably connected to a marine vehicle, which includes a transformer device for converting into lower and/or higher electrical voltage, an electrolysis device for generating hydrogen, and a tank for storing the hydrogen. The invention advantageously provides for dynamic changes between the operating modes of storage and transmission, redundancy and maintainability.

### BACKGROUND

The invention relates to the system for generating energy by means of an offshore wind turbine installation, and to a floating generation and storage unit.

The invention further relates to a floating generation and storage unit for the conversion, storage and transmission of energy, which unit is electrically connected to an offshore windfarm for generating energy.

The invention comprises a modular system comprised of a conventional power transmission function (HVAC/HVDC) and the production, storage and transport of hydrogen in conjunction with a FPSO (floating production and storage unit). The offshore transformer substation is electrically connected to a wind turbine (WEA) cluster.

Electric power grid infrastructure restricts energy generation and the injection of renewable energies into the grid. For the maintenance of grid stability, grid system operators continue to execute the switch-out of dynamically controllable wind and solar energy sources. Energy storage, for example by means of hydrogen as an energy carrier, is assuming increasing significance, wherein the run-up of hydrogen production is driven by infrastructure issues. Attention is focused on offshore projects of the order of 500 MW or greater. The volatile load spectrum of wind turbines dictates a dynamic run-up of electrolysis units. At present, this requirement, in combination with a high technical readiness level, is primarily achievable by means of PEM (proton exchange membrane) stacks. In comparison with alkaline electrolyzers, for example, these assume a larger footprint (transmission capacity). In combination with large transmission capacities, initial investigations have revealed that electrolysis units cannot be integrated in existing platform designs. Moreover, platforms having a hydrogen transmission capacity in excess of 900 MW, on the grounds of weight, and in excess of 600 MW, on the grounds of the requisite surface area, are not achievable on the basis of the present state of development of electrolyzers.

### SUMMARY

The invention addresses the fundamental issue of providing an energy generation system having a capacity rating in excess of 500 MW by means of an offshore wind turbine installation, which system is flexibly adaptable to different transmission and consumption capacities.

The present invention, in addition to a hybrid transmission function, incorporates integration by means of a detachable and rotatably mounted slipring connection (or “swivel system”), providing advantages such as, for example, storage capability, maintainability, redundancy, dynamic changeover between operating modes, etc.

The hybrid system provides for a transformation of electrical energy, firstly to a higher voltage level, for the export thereof to an onshore substation, and secondly to a lower voltage level, in order to enable the appropriate supply of energy to the electrolysis unit.

### BRIEF DESCRIPTION OF THE DRAWINGS

An exemplary embodiment of the invention is described in greater detail hereinafter, to the extent which is necessary for the purposes of understanding, with reference to the figures. In the figures:

FIG. 1 shows a schematic connection of a wind turbine installation to a platform and to a floating generation and storage unit;

FIG. 2 shows a schematic connection of a wind turbine installation to a floating generation and storage unit;

FIG. 3 shows a mooring system, which is fitted to the floating generation and storage unit;

FIG. 4 shows a keel-integrated solution;

FIG. 5 shows an external turret mooring system;

FIG. 6 shows an underwater connection; and

FIG. 7 shows the arrangement of H₂ tanks T in the floating generation and storage unit.

In the figures, identical symbols identify identical elements.

### DETAILED DESCRIPTION

The system described hereinafter represents a hybrid solution which combines the generation of green hydrogen with electricity transmission. The hybrid system provides the following advantages:
Increased availability associated with two operating systems/energy supply systems which function in a substantially mutually independent manner;
Surmounting of critical electricity transmission system infrastructure issues by the transmission of energy using hydrogen;
Dynamic and needs-based electrical load control (hydrogen-driven/power-driven);
Reduction of OPEX associated with optimized maintenance operations vis-à-vis decentralized offshore hydrogen production systems;
Reduction of CAPEX;
Cabling: reduction of cable cross-section, which reduction specifically impacts as the distance from the shore increases.

The hybrid system provides for a transformation of electrical energy, firstly to a higher voltage level for export to an onshore substation, and secondly to a lower voltage level for the appropriate supply of energy to the electrolysis unit.

Two different approaches are disclosed.

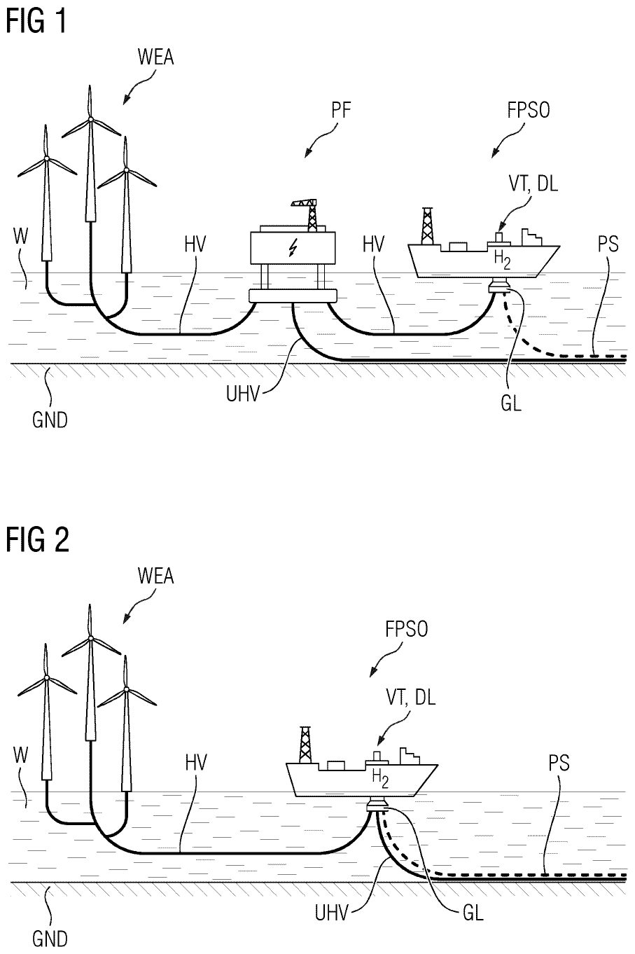

In variant a) WEA—platform—FPSO, according to FIG. 1, the windfarm WEA is electrically developed to incorporate a platform PF.

By means of a detachable connection VT, DL, the FPSO can be decoupled from the offshore transformer platform PF. The entire FPSO, for the purposes of maintenance operations, can be transported in-dock, and these operations executed onshore. As a result, no offshore-certified workforce is required for scheduled and unscheduled maintenance and repair operations. Consequently, any costs associated with the transport of crew to the FPSO are entirely eliminated. During maintenance operations on the electrolysis system, onshore HV electricity transmission is not affected.

High-voltage equipment, in its entirety, is located on the transformer platform PF, which equipment includes the following components: Switchgear; Transformer TR; HVDC/AC converter (VSC, or “voltage source converter”); and a Reactance coil.

The electrical system additionally incorporates units for cooling, control and regulation, safety and communication. The design of the electrical system primarily employs conventional equipment, for which no fundamentally novel developments are required.

Subsystems of the FPSO include the following units, wherein extensions/adaptations thereof are possible: Electrolysis stack ES; Water treatment system (desalination, demineralization, deionization); Cooling system; Compression system; Intermediate store T; Low-voltage and auxiliary systems; and Tower mooring system VT, with rotatably mounted slipring connection SR.

The hybrid model, which is employable, for example, for a capacity rating in excess of 500 MW, can be switched to different operating modes. According to consumer-side demand, the operator can distinguish between two approaches. The first approach is referred to as Hydrogen-controlled. In this approach, electricity is generated by the wind turbine installation WEA/hub/cluster is primarily employed for the coverage of the rated capacity of the electrolyzer, whereas any residual electricity is transmitted onshore by means of the HVDC/AC transmission unit, via the HV submarine cable. In this case, the electrolyzer employs the power generation base load. The first approach is referred to as Power-controlled. In the second approach, the electrolyzer employs only surplus electricity generated. In this case, the coverage of electric power demand assumes precedence, and the electrolyzer accommodates the peak load.

Moreover, as a result of hybrid transmission and the substantial mutual independence of electricity generation and hydrogen production operations, maintenance operations can be executed without shutting down the entire system. By definition, redundancies in the interests of trouble-free operation are provided by the two different energy transmission options. A further advantage is the individual actuation of electrolyzer modules, as a result of which the degradation of the stack is reduced, and it is not necessary for any transmission losses to be taken into consideration.

In variant b) WEA—platform—FPSO, according to FIG. 2, an offshore platform is entirely omitted. The WEA cluster is directly connected to the FPSO. The FPSO is fitted with the equipment of an offshore transformer platform, and can be designed both as a unit for the production of hydrogen only, and as a hybrid unit, one element of which is employed for hydrogen production, and another element of which is employed for electricity transmission (UHV).

Both the electrical system and the electrolysis unit, in principle, are analogous to variant a), and are distinguished, inter alia with respect to the electrical design of individual components, layout, safety concept and automation concept. The fundamental functionalities are identical.

The modular system enables a flexible and customer-specific solution, together with a locational change of the FPSO, and thus the integration thereof in another windfarm of a similar capacity rating with a relatively limited complexity of adaptation.

### FPSO Integration

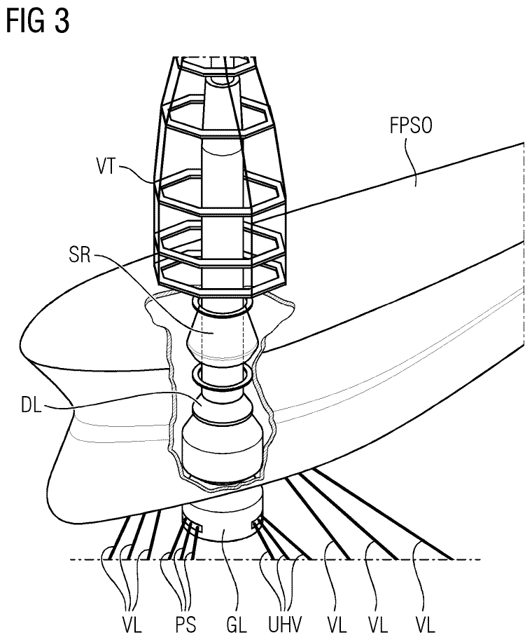

As represented in FIG. 3, the FPSO is mechanically secured by means of a mooring system (or “turret mooring system”). This system comprises a mooring turret VT which is mounted on the FPSO, and from which the mooring lines VL originate. Whereas the mooring lines VL connect to the seabed GND in a geostationary arrangement, the rotatably mounted slipring connection SR (or “swivel system”) enables the turret mooring system to rotate about the pivot point S. An improved and weather-dependent orientation of the stern of the vessel is thus ensured, with the objective of reducing motion and acceleration on the vessel to a minimum. The primary purpose of the swivel system is the compensation of movements of the vessel generated by wind, waves and currents and, at the same time, to maintain the continuity of fluid transfer and the electrical connection. This system enables the vessel, under changing environmental conditions, to rotate freely, with no resulting inordinate loading of mooring structures.

The detachable mooring system enables a complete physical uncoupling of the FPSO. By means of the slipring connection SR, the FPSO can be supplied with electricity generated by the wind turbine installation WEA via flexible/dynamic cables, and can also be connected to the hydrogen system by means of a flexible piping system PS. In addition to connection to the hydrogen system, an option is also available for the storage of hydrogen in a tank which is integrated in the FPSO, and for hydrogen produced to be transported onshore by means of cargo vessels.

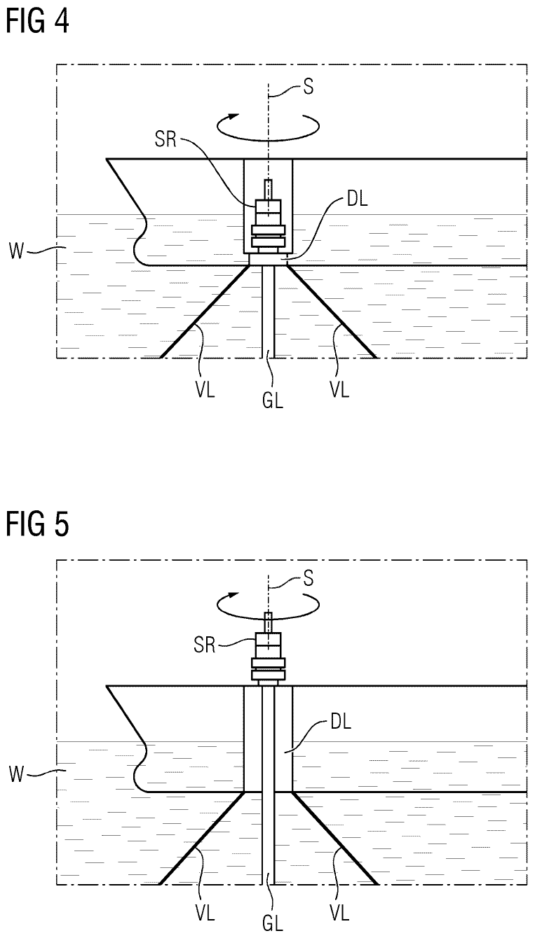

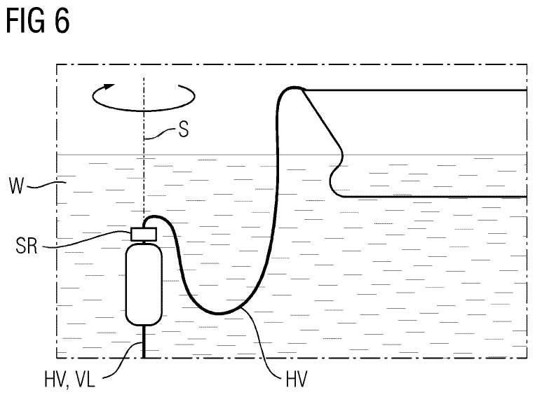

Depending upon available space on the FPSO and requirements in force, the system according to the invention can be embodied as a keel-integrated solution, as represented in FIG. 4, as an external turret mooring system, as represented in FIG. 5, and as an underwater connection, as represented in FIG. 6.

The mooring system, but also the counter bearing GL, can be arranged separately, at a distance from the wind turbine installation WEA, but can also be arranged on the platform PF.

### Integrated FPSO Tank System

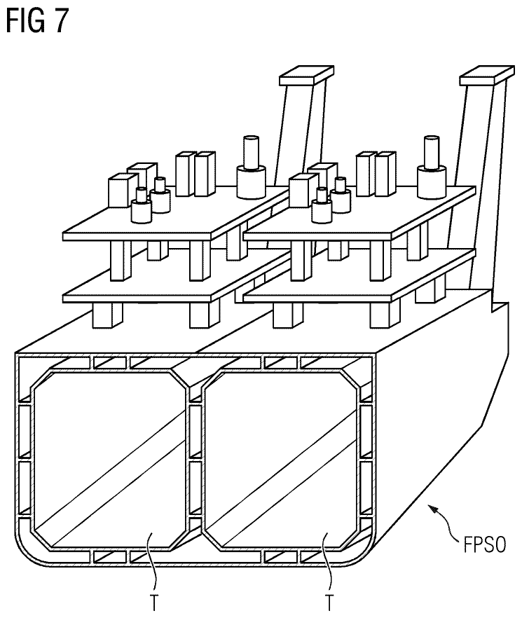

As an alternative to the pipeline connection, tanks T for the storage of hydrogen H₂ are arranged in the stern of the FPSO, by way of storage capacities (see FIG. 7).

The electrolysis stacks ES, together with ancillary systems, assume the greater space requirement, in comparison with the high-voltage transmission function HVDC. As the capacity of the electrolysis unit ES increases, so the space requirement rises substantially. Depending upon the requisite transmission capacity, and the associated proportion of available structural space, the electrolysis stacks ES can also be integrated in the existing volume of the tanks, and a higher output of hydrogen, but also a higher electricity transmission capacity, can thus be achieved by the employment of a FPSO of the same size. The dynamic behavior of the FPSO, and resulting accelerations and movements, can thus be optimized.

The system according to the invention includes:
A modular layout for the integration of a hydrogen production unit in a 33/66/132 kV windfarm;
Integration of a high-voltage transmission function and/or of electrolysis units only in a FPSO;
The optional employment of a tank system T in the stern of the FPSO, for the storage of hydrogen H₂;
A flexible scalability of transmission capacity, with no fundamental alteration of the layout of the FPSO; and
Connection of the FPSO by means of a rotatably mounted and quick-release mooring system, in conjunction with an energy transmission system for both electricity and fluids.

The term “fluid” includes hydrogen and derivatives thereof such as, for example, ammonia, liquid organic hydrogen carriers (LOHCs), etc.

For the purposes of illustration, the present invention has been described in detail with reference to specific exemplary embodiments. Elements of the individual exemplary embodiments can also be mutually combined. Consequently, the invention is not limited to individual exemplary embodiments, wherein any limitation proceeds only from the attached claims.

### LIST OF REFERENCE SYMBOLS

AC—Alternating current
CAPEX—Capital expenditures
DC—Direct current
ES—Electrolysis stack, electrolysis unit
FPSO—Watercraft, floating production and storage unit
GIS—Gas-insulated switchgear
GL—Counter bearing
GND—Seabed, ground
H₂—Hydrogen
HV—High voltage
HVDC—High-voltage DC converter, high-voltage DC power transmission
IGBT—Insulated-gate bipolar transistor
LOHC—Liquid organic hydrogen carriers
MV—Medium voltage
Offshore—At sea
OPEX—Operating expenditures
Onshore—On land
PF—Platform
PS—Fluid line, flexible hydrogen line, piping system
S—Perpendicular, vertical axis, pivot point
SR—Slipring, swivel system
T—Tank system in the stern of the FPSO for storing hydrogen
TR—High-power transformer
UHV—Ultra-high voltage
VSC—Voltage source converter
VL—Mooring line
VT—Turret mooring system
W—Water, open water (offshore)
WEA—Wind turbine installation, hub, cluster

1. A system for generating energy using a wind turbine installation in open water, the system comprising:
a floating production and storage unit, having a rotary bearing which cooperates with a counter bearing which is secured to a seabed, is rotatably mounted about a vertical axis at a location of the counter bearing;
the counter bearing is electrically connected to the wind turbine installation;
the rotary bearing and the counter bearing comprise a coupling mechanism for mutual release or attachment; and
the rotary bearing cooperates with the counter bearing, by means of a rotatably mounted slipring, for transmission of electrical energy and/or of a fluid, in particular hydrogen from and to the floating production and storage unit.

2. The system as claimed in claim 1,
wherein
the rotary bearing cooperates with the counter bearing such that a transmission of a fluid from the floating production and storage unit is enabled in a piping system.

3. The system as claimed in claim 1, wherein
the rotary bearing cooperates with the counter bearing such that a relative movement in the a direction of the vertical axis is enabled.

4. The system as claimed in claim 1, wherein
the rotary bearing cooperates with the counter bearing such that a tilting movement with respect to the vertical axis is enabled.

5. The system as claimed in claim 1,
wherein the counter bearing is secured to the seabed of open water by means of mooring lines.

6. The system as claimed in claim 1, wherein
an electrolysis unit for generating hydrogen is arranged on the floating production and storage unit.

7. The system as claimed in claim 6,
wherein
on the floating production and storage unit, a transformation of a high voltage of the wind turbine installation, in particular 66/132 kV, into a low voltage, in particular 600-800 V, of a electrolysis unit is enabled.

8. The system as claimed in claim 6, wherein
on the floating production and storage unit a transformation of a high voltage of the wind turbine installation, in particular 66/132 kV, into a ultra-high voltage, in particular 320 kV/525 kV, of a connected long-distance transmission system, is enabled.

9. The system as claimed in claim 1, wherein
the counter bearing is electrically connected to the wind turbine installation by means of a platform (PF).

10. The system as claimed in claim 9,
wherein on the platform, a transformation of a high voltage of the wind turbine installation, in particular 66/132 kV, into a ultra-high voltage, in particular 320 kV/525 kV, of a connected long-distance transmission system, is enabled.

11. The system as claimed in claim 9, wherein
the floating production and storage unit comprises a tank system for the storage of hydrogen produced.
